(19) United States
(12) Patent Application Publication
(10) Pub. No.: US 2019/0351647 A1
(43) Pub. Date: Nov. 21, 2019

(54) METHOD AND APPARATUS FOR FORMING THERMOPLASTIC LOW POROSITY COMPOSITE LAMINATE

(71) Applicant: TRIUMPH AEROSTRUCTURES, LLC., Arlington, TX (US)

(72) Inventor: Mark A. Calder, Midlothian, TX (US)

(21) Appl. No.: 16/414,737

(22) Filed: May 16, 2019

Related U.S. Application Data
(60) Provisional application No. 62/674,124, filed on May 21, 2018.

(51) Int. Cl. B32B 5/26; C08J 5/24; C08J 3/20

(52) U.S. Cl. CPC B32B 5/26; C08J 3/20; C08J 5/24

(57) ABSTRACT

A system for forming low porosity carbon fiber reinforced thermoplastic laminate. An apparatus includes a first heating element for heating a plurality of layers of a composite laminate. A second heating element heats a ply of composite material as the ply is applied onto the heated laminate. A pressure element applies pressure to the laminate to consolidate the laminate after the ply has been applied to the laminate.

### PRIORITY CLAIM

The present application claims priority to U.S. Provisional Patent Application No. 62/674,124 filed on May 21, 2018. The entire disclosure of the foregoing application is hereby incorporated herein by reference.

### FIELD OF THE INVENTION

The present invention relates to the field of composite materials. In particular, the present application relates to thermoplastic composite materials. More specifically, the present invention is directed toward a method and apparatus for forming composite laminates having low porosity.

### BACKGROUND

Composite materials have been used in a wide variety of applications in which the benefit of low weight high strength materials outweigh the cost of the materials. For instance, historically, aerostructures have been formed of lightweight metals, such as aluminum and more recently titanium. However, a substantial portion of modern aircraft is formed from composite materials. A commonly used material in the aerospace industry is carbon fiber reinforced thermoplastic. The known manufacturing processes have the potential for causing porosity, which is the presence of small voids or air pockets in the thermoplastic matrix material. Porosity can adversely affect the mechanical properties of the composite materials. Accordingly, it is desirable to minimize the porosity of a composite laminate.

Porosity can be a concern in applications in which the laminate is being formed on a tool, such as a mold intended to give the laminate a shape. When the laminate is a relatively small flat laminate, the layers can be laid up and then the entire laminate can be heated up under pressure at the same time, thereby reducing porosity. However, when the laminate is laid up over a mold the laminate is formed layer by layer. As a layer is added, the new layer is heated and pressure is applied to fuse to the new layer to the underlying layer(s). In such situations, pressure is only localized rather than being applied to the entire laminate. As such, the potential for porosity in increased.

Accordingly, there is a need for a system for forming low porosity laminates.

### SUMMARY OF THE INVENTION

In view of the shortcomings of the prior art, according to one aspect, the present invention provides a method and apparatus for producing low porosity composite laminates.

According to one aspect, the present invention provides an apparatus for forming a multi-layer carbon fiber reinforced thermoplastic laminate on a form. The apparatus includes a holder configured to hold a length of carbon fiber reinforced thermoplastic tape and a feeder for advancing the tape from the holder toward an intersection where the tape intersects with the form or the laminate. The apparatus also includes a tape heating device, a compaction device and a laminate heating device. The tape heating device is configured to heat the tape and a top layer of the laminate to a first temperature that is above the melting point of the tape thermoplastic. The tape heating element directs the heat at the intersection across substantially the entire width of tape. The compaction device is configured to apply pressure against the tape adjacent the intersection to fuse the tape with the laminate after the tape heating element heats the tape and the top layer of the laminate to the first temperature. The laminate heating device includes an induction heating device and is spaced apart from the compaction device so that the laminate heating device is positioned so that the laminate heating device heats the laminate without heating the tape being applied to the laminate. The apparatus may also include a drive assembly connected with the tape heating device, compaction device and laminate heating device. The drive assembly may be configured to control the position of the tape heating device, compaction device and laminate heating device to displace the tape heating device, compaction device and laminate heating device along X, Y and Z axes.

According to another aspect, the present invention provides an apparatus for forming a multi-layer carbon fiber reinforced thermoplastic laminate on a form. The apparatus includes a drive assembly and a tape laying assembly. The drive assembly is configured to displace the tape laying assembly along at least two axes. The tape laying assembly includes a feed module a tape heating module, a compaction module and a pre-heating module. The feed module is operable to feed carbon fiber reinforced tape toward the form or onto a top surface of one or more layers of carbon fiber reinforced thermoplastic laid on the form. The tape heating module is configured to heat the tape and the top surface at a point where the tape is laid on the top surface. The compaction module is positioned downstream from the point where the tape heating module heats the tape and the top surface and is configured to apply pressure to the tape to fuse the tape with the top layer. The pre-heating module is positioned upstream from the point where the tape heating module heats the tape and the top surface and the pre-heating module is configured to heat a plurality of the layers on the form prior to the tape being laid onto the plurality of layers.

According to a further aspect, the present invention provides a method for forming a multi-later carbon fiber reinforced thermoplastic laminate The method includes the steps of A) providing a form having a shape and B) feeding a first layer of carbon fiber reinforced thermoplastic material into engagement with the form so that the first layer is a top layer. According to step C) a subsequent layer of carbon fiber reinforced thermoplastic material is fed onto the top layer so that the top layer becomes the second layer and the subsequent layer becomes the top layer. In step D) the top layer and the second layer are heated to a temperature above a first temperature as the top layer is fed onto the second layer. In a step E) pressure is applied to the top layer and the second layer after the step of heating, wherein the pressure fuses the top layer with the second layer. Steps C through E are repeated a plurality of iterations to form a laminate having a plurality of layers. The second layer and layers below the second layer are heated during each iteration before the step of heating the top layer.

According to still another aspect, the present invention provides a method for forming a carbon fiber reinforced thermoplastic laminate including the step of applying a first layer of unidirectional carbon fiber reinforced thermoplastic having a fiber direction in a first direction. A second layer of unidirectional carbon fiber reinforced thermoplastic material is applied onto the first layer, wherein the second layer has a fiber orientation that is transverse the fiber orientation of the first layer. The first and second layers are heated at an intersection that extends across a width of the second layer. Pressure is applied to the first and second layers across the width of the second layer to fuse the second layer with the first layer. A third layer of unidirectional carbon fiber reinforced thermoplastic material have a fiber direction that is transverse the fiber direction of the second layer is applied onto the second layer. The first and second layers are heated after the step of applying pressure to the first and second layers and prior to the step of applying the third layer. Additionally, the second and third layers are heated at an intersection of the second and third layers during the step of applying the third layer. Pressure is then applied to the third layer after the step of heating the second and third layers to fuse the third layer to the second layer.

While the methods and apparatus are described herein by way of example for several embodiments and illustrative drawings, those skilled in the art will recognize that the inventive methods and apparatus for sorting items using a dynamically reconfigurable sorting array are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the methods and apparatus for sorting items using one or more dynamically reconfigurable sorting array defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DESCRIPTION OF THE DRAWINGS

The foregoing summary and the following detailed description of the preferred embodiments of the present invention will be best understood when read in conjunction with the appended drawings, in which:

FIG. 1 is a diagrammatic view of a system for forming a thermoplastic laminate; and

FIG. 2 is a diagrammatic view of a portion of the system illustrated in FIG. 1;

### DETAILED DESCRIPTION OF THE INVENTION

Referring now to the figures in general, a system for forming a composite laminate is designated generally 10. The system 10 is an automated tape laying machine designed to lay a composite laminate on a form 5 so that the composite laminate conforms to the shape of the form. The form may any of a variety of elements, including, but not limited to a mold or a mandrel. Additionally, the form may be a plate so that the laminate is generally planar. The tape laying machine includes a control arm 20 and a tape laying head 30 connected with the control arm. The control arm 20 is moveable to displace the tape laying head 30. The control arm 20 repeatedly displaces the tape laying head 30 to lay a series of layers onto the form 5 to build up the laminate layer by layer.

The tape laying head 30 is configured to lay any of a variety of composite materials. However, in the present instance, the head is configured to lay down carbon fiber reinforced thermoplastic material. In particular, the head 30 is configured to handle strips of carbon fiber reinforced thermoplastic material. The strips may be any of a variety of widths. For instance, the width of each strip may be as narrow as ¼″ or as wide as 6 or 12″. Accordingly, the tape laying head is not limited to include any particular composite material or any particular width of material. Accordingly, in the following description, although the head 30 is referred to as a tape laying head, the term as used herein is defined broadly enough to include any system for laying down carbon fiber reinforced composite materials, including, but not limited to systems referred to as automated tape laying heads or automated fiber placement heads.

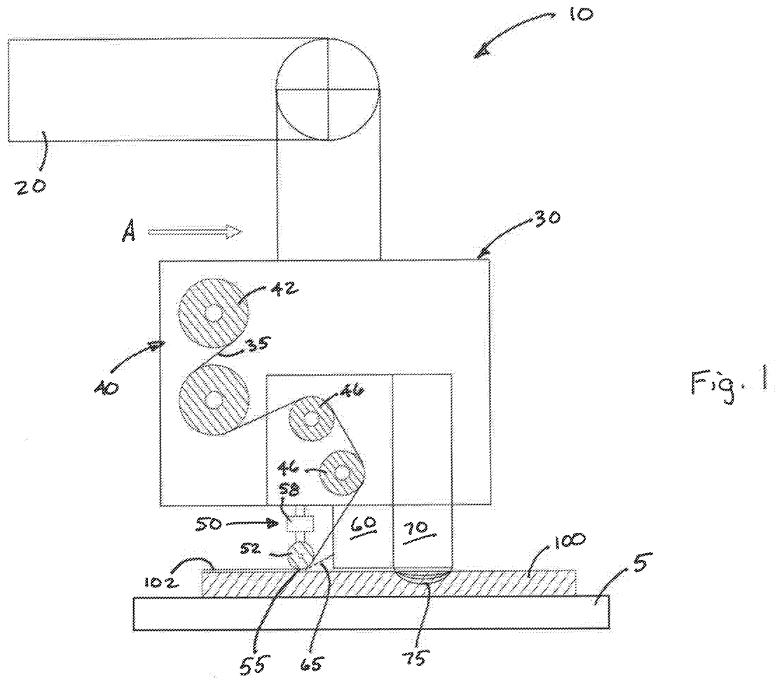

Referring to FIG. 1 a brief overview of the system 10 is provided. The control arm 20 is moveable relative to the form 5, which in the present instance is illustrated as a flat plate, so that the resulting laminate 100 is a flat panel. The control arm 20 moves the tape laying head back and forth across the form 5 to build up a series of layers forming the laminate. The control arm 20 in two dimensions to lay a pattern of carbon fiber tape forming a first layer. For example, the arm may move side to side in the X direction to lay down a strip of material and then move in the Y direction before laying down the next strip next to the first strip of material. Continuing in the fashion, the system may lay a series of side by side strips forming a first layer. The control arm 20 move in a third direction, such as the Z direction to move upwardly to lay a second layer. The control arm may also change direction to lay a series of strips in a transverse direction onto the first layer to cover the first layer. The control arm 20 may continue to move according to a predefined path, varying direction and orientation to move the tape laying head 30 over the form to lay a series of strips onto the form 5.

It should be understood that the form 5 may have any of a variety of shapes. Although the form 5 is illustrated as a flat panel for clarity of the illustrations, the form may be any of a variety of shapes and sizes. The form may be concave so that the strips are deposited into the form to create a convex laminate. Similarly, the form may be concave so that the strips are laid over the form to create a concave laminate. In this way, the finished laminate may have a complex three-dimensional geometry. For instance, the laminate may be used in a variety of structures in a variety of fields and may have particular application in the field of aerospace to provide a variety of components, including, but not limited to airframes, nacelles and airfoils, such as wings, elevators etc.

The system 10 the control arm 20 and the tape laying head 30. The head 30 includes a tape heating module 60 for heating the tape as it is applied to the laminate and a compaction module 50 for applying pressure to the tape to fuse the tape with the laminate. Additionally, the tape laying head 30 includes a laminate heating module for heating the laminate prior to depositing a new layer of tape onto the laminate. By heating the laminate prior to applying the new layer, the compaction module is able to compact multiple layers of the laminate, thereby minimizing the presence of gas pockets throughout the laminate to reduce the laminate's porosity.

The control arm 20 may be any of a variety of moveable systems designed to move the tape laying head 30. For instance, the control arm 20 may comprise a multi-arm linkage configured to provide three degrees of freedom of translator motion and three degrees of freedom of rotation motion. However, the control arm may provide fewer degrees of freedom of motion. In this way, the control arm is operable to control the position and orientation of the tape laying head 30. Additionally, although the control arm 20 is illustrated as a multi-bar linkage, the control mechanism may incorporate alternate structures, such as a rail or a gantry. Accordingly, the control arm 20 can be any structure connected with the tape laying head that provides for the controlled displacement of the tape laying head. The system also includes an electronic controller configured to control the operation of the control arm to control the position and orientation of the tape laying head. For instance, the controller may be a microprocessor programmed to control the operation of the control arm. The controller may also be configured to control operation of the tape laying head as the control arm moves the head. For instance, the controller may be configured to control the displacement of the tape laying head so that the head follows a predetermined path when laying down a series of lengths of carbon fiber reinforced thermoplastic material.

As noted previously, the system 10 is operable in connection with a plurality of materials. However, in the particularly suited for forming laminates of a plurality of layers of carbon fiber reinforced thermoplastic materials. A variety of such materials can be used. Depending upon the application, the reinforcing elements may be any of a variety of reinforcing materials. By way of example, the reinforcing elements may be elongated strands or fibers of glass or carbon, however in the present instance the reinforcing elements are conductive materials, such as carbon fiber. For instance, an exemplary carbon fiber is a continuous, high strength, high strain, PAN based fiber in tows of 3,000 to 12,000. In particular, in the present instance, the reinforcing elements are carbon fibers produced by Hexcel Corporation of Stamford, Conn. and sold under the name HEXTOW, such as HEXTOW AS4D. These reinforcing fibers may be treated with a surface treatment and may be sized to improve its interlaminar shear properties with the matrix material. However, it should be understood that these materials are intended as exemplary materials; other materials can be utilized depending on the environment in which the laminate is to be used.

The reinforcing elements are embedded within a matrix material, such as a polymer. Depending on the application, any of a variety of polymers can be used for the matrix material, including amorphous, crystalline and semi-crystalline polymers. In the present instance, the matrix material is a thermoplastic material, such as a thermoplastic elastomer. More specifically, the thermoplastic material is a semi-crystalline thermoplastic. In particular, the thermoplastic may be a thermoplastic polymer in the polyaryletherketone (PAEK) family, including, but not limited to polyetheretherketone (PEEK) and polyetherketoneketone (PEKK).

As noted above, the material laid by the tape laying head may be carbon fiber reinforced thermoplastic composites. In particular, the lamina may be thermoplastic prepregs, which are laminae in which the reinforcement materials have been pre-impregnated with resin. For instance, the prepreg may be thermoplastic prepregs produced by coating reinforcement fibers with a thermoplastic matrix. Such a prepreg lamina has the ability to be reheated and reformed by heating the lamina above the melting point of the thermoplastic matrix. Several exemplary prepreg materials that may be used to form the structural elements 25, 26 include, but are not limited to, materials produced by TenCate Advanced Composites USA of Morgan Hill, Calif. and sold under the name CETEX, such as TC1200, TC1225 and TC1320. TC1200 is a carbon fiber reinforced semi-crystalline PEEK composite having a glass transition temperature (T_{g}) of 143° C./289° F. and a melting temperature (Tₘ) of 343° C./649° F. TC1225 is a carbon fiber reinforced semi-crystalline PAEK composite having a T_{g} of 147° C./297° F. and a Tₘ of 305° C./581° F. TC1320 is a carbon fiber reinforced semi-crystalline PEKK composite having a T_{g} of 150° C./318° F. and a Tₘ of 337° C./639° F.

In the following discussion, the composite material being laid by the tape laying head 30 will be referred to as tape, which as discussed above includes any length of composite material regardless of the width of the material.

The system 10 includes a tape storage module 40 for storing a supply of tape 35 that is to be fed to the tape laying head 30. For instance, the system 10 may include a reel or spool 42 and the tape 35 may be wound or coiled around the reel. The storage reel 42 may be connected with the tape laying head 30 so that the reel moves along with the head as shown in FIG. 1. Alternatively, the reel may be separate from the head 30 so that the head can move relative to the reel. Additionally, although the system is illustrated as including a single reel 42, it should be understood that the tape storing module may include a plurality of storage elements for storing a plurality of types of tape. For instance, the storage module 40 may include a plurality of reel and each reel may store a different width of tape. Additionally, or alternatively, each reel may store tapes having different reinforcing elements or different matrix resins. For example, the different tapes may have different thermoplastic matrix resins having different melting points.

The number of structural plies and the orientation of the plies in the laminate may vary depending on the application. It should be understood that the number of plies, the orientation of the plies, as well as the number and location of the insulating layers 60 are only an example; the invention is not limited to the lay-up illustrated in this exemplary laminate.

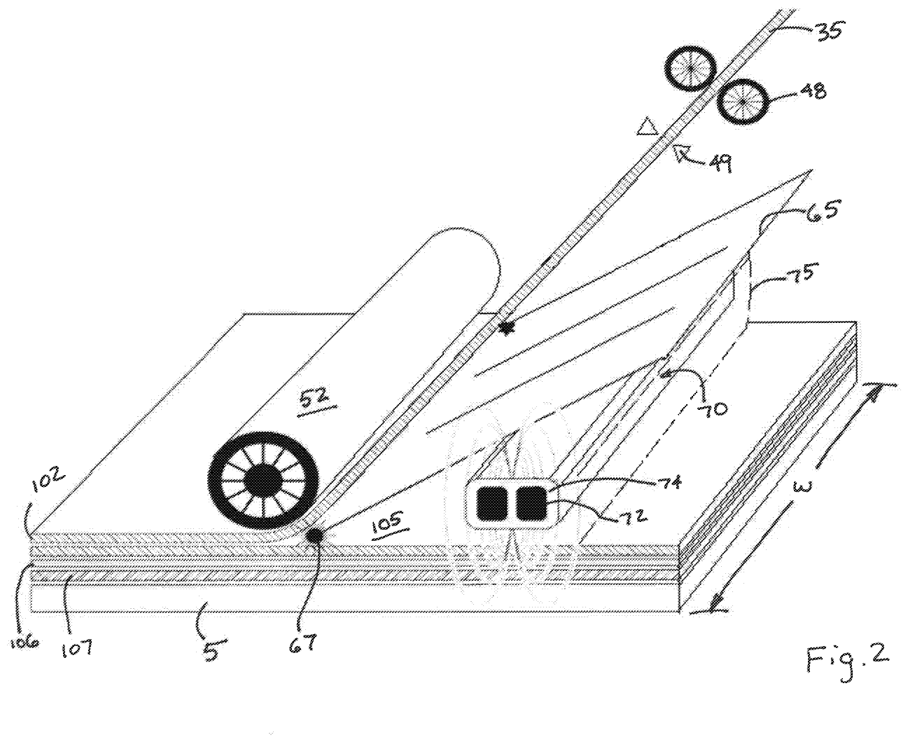

The laminate includes a plurality of structural layers designated 102, 105, 106 and 107 in FIG. 2. As described above, each structural layer may be a lamina or layer of composite material, such as unidirectional carbon fiber reinforced thermoplastic tape. The fiber direction for each structural layer may vary to provide strength in a plurality of directions. For instance, the first layer in the laminate is designated 102 and has a fiber direction of 45° and the second layer in the laminate is designated 105 and has a fiber angle of 0°. The third layer 106 may have a fiber direction of 45° and the fourth layer 107 may have a fiber direction of 90°. The laminate may be formed so that it is symmetric about its midline. In the present instance, applying another layer having a fiber direction of 90° on top of the first layer 102 would provide a laminate having five layers that is symmetric about layer 105.

It should be noted that the thickness of the layers in the Figures are not to scale and in some instances the thickness is exaggerated for illustration purposes only. For instance, in FIG. 2, the structural layers 102, 105, 106, 107 are depicted as having gaps between adjacent layers. However, it should be understood that the layers in the laminate are consolidated layers in which the different layers have been fused together.

The details of the tape laying head will now be described in greater detail. As noted above, the system may include a storage module 40 for storing a length of tape 35 and the storage module 40 may be part of the tape laying head 30 or it may be a separate element. The tape 35 is fed from the storage reel 42 through a series of guide elements and deposited at a discharge nip 55. At the discharge nip the tape is laid onto an underlying structure. In most instances, the underlying structure is either the form 5 or a previously laid layer of composite material.

As shown in FIGS. 1-2, the system 10 may include one or more drive rollers for advancing the tape 35 from the reel 42 to the discharge nip 55. For instance, as shown in FIG. 2, the head 30 may include a pair or drive rollers 48 that form a nip and the tape may pass through the nipped drive rollers. The rollers 48 may be driven rollers so that driving the drive rollers forwardly drives the tape 35 through the nip to advance the tape toward the discharge nip. In this way, driving the drive rollers 48 pullers the tape from the reel 42 to advance a length of the tape. Additionally, the tape may wind around one or more guide roller 46 that guide the tape between the spool 42 and the drive rollers 48.

From the drive roller 48, the tape 35 advances toward the form 5 if the tape forms the first layer, or the top layer 105 of the laminate 100 if one or more layers have already been deposited or laid on the form. The point where the tape first comes into contact with the form or the top layer 105 of the laminate is referred to as the intersection and in the present instance the intersection is at or adjacent the nip 55 formed between the compaction roller 52 and the form or the laminate.

The tape laying head 30 include a tape heating module 60 for heating the tape 35 at the intersection of the tape and the form or the laminate. In particular, the tape heating module is configured to direct a heat source at the intersection to heat both the tape 35 and the top layer 105 of the laminate. In particular, the tape heating module is configured to rapidly heat the tape and the top layer of the laminate to a temperature at or above the melting point of the matrix material of the tape. For instance, as described above, the tape may have a thermoplastic resin, such as PEEK, so the tape heating module may heat the tape and the top layer of the laminate to a temperature over 650° F.

Since the tape is moving, the tape heating module provides a concentrated heat source focused on a small area at the intersection of the tape and the top layer 105. The small area at the intersection at which the heat is directed is referred to as the welding zone 67. The weld zone 67 extends across the entire width “w” of the tape 35. The tape heating module is configured to provide focused heat simultaneous across the entire weld zone to melt the tape and the top layer across the width of the tape and across a width of the top layer corresponding to the width of the tape. In particular, in FIG. 2 the width of the laminate 100 is the same as the width of the tape 35 being laid on the laminate. However, it should be appreciated that typically the underlying layer or layers will be formed of a plurality of strips of tape so that the underlying layers are substantially wider than the width of the tape. When the tape is laid on the underlying layers, the top layer only needs to be heated across the width of the top layer corresponding to the width of the tape being laid on the laminate.

The tape heating module may incorporate any of a variety of heating elements operable to provide a focused heat source. For instance, heating elements such as hot gas heaters, flames, ultrasonic, infrared or induction heaters may be used to heat the tape in the weld zone. However, in the present instance, the tape heating module incorporates a laser heating assembly. For example, an exemplary laser heating module may comprise a plurality of laser diodes disposed in one or several rows, such as laser diodes that emit radiation having a wavelength of between 880 and 1030 nm. An exemplary laser heating assembly is a fiber coupled diode laser having two stacks, such as the LDF 6000-100 6,000 watt laser manufactured by Laserline Inc. of Santa Clara, Calif. Alternatively, the laser heating module may incorporate an optical fiber laser or a YAG laser. Accordingly, it should be understood that the tape heating module may include any of a variety of heating elements configured to provide focused heat.

As noted above, in the present instance, the laser heating assembly provides a focused high intensity laser operable to provide a sheet of heat 65 focused on the weld zone 67. In this way, the tape heater rapidly heats the portion of the top layer 105 and the tape 35 adjacent the nip 55 so that the tape and the top surface have reached the melting point of the thermoplastic before the tape and the top layer pass under the compaction module 50. The tape laying head 30 moves relative to the laminate, so the tape and the top layer of the laminate are heated as the tape is being laid on the top layer of the laminate. In this way, the speed at which the tape can be laid is limited by the speed at which the tape heating module can heat the tape and the top surface of the laminate to the temperature need to melt the thermoplastic resin in the tape and the laminate to fuse the tape to the top layer of the laminate. Accordingly, it is desirable to configure the tape heating module so that the heating element is able to elevate the material in the weld zone to the melting temperature in a short period of time. In particular, the tape heating module 60 is configured to heat the material in the weld zone to over 650° F. in less than a second. Further still, the tape heating module may be configured to heat the material in the weld zone to over 650° F. in less than 0.5 seconds and in some instance the tape heating module may be configured to heat the material in the weld zone to over 650° F. in less than 0.1 seconds.

The tape laying head 30 also includes a compaction module 50 positioned adjacent the weld zone 67. The compaction module 50 is configured to apply pressure to the newly applied tape and the top layer of the laminate 100 below the newly applied tape. The compaction module may incorporate any of a variety of elements for applying pressure to the tape as the tape is fed under the compaction module. For instance, the compaction module may a plate, fence or guide, such as a rounded guide. In the present instance, the compaction module includes a roller 52 that extends across the width of the weld zone 67. For example, as shown in FIG. 2, the roller may be an elongated cylindrical roller. Additionally, the roller may have an outer surface that is elastically and resiliently deformable. For instance, the roller may include an outer surface formed of elastomeric material that is readily deformable to conform to the shape of the form 5 to urge the tape 35 into the details of the form.

The compaction module 50 also includes a biasing element 58 for biasing the compaction roller 52 toward the form 5 or the laminate. The biasing element provides the downward force against the tape 35 and the laminate to provide the requisite pressure for fusing the tape with the top layer of the laminate. The biasing element 58 provides sufficient force to provide pressure along the entire weld zone 67. The biasing element may be any of a variety of elements, including but not limited to hydraulic, pneumatic, elastomeric and spring elements.

The tape laying head 30 may also include a cutting device 49 for severing the tape 35 as the tape is advanced along the path toward the nip 55. The cutting device 49 may be any of a variety of elements configured to sever a length of carbon fiber reinforced thermoplastic tape, including, but not limited to mechanical knives, shears, ultrasonic knife and lasers.

To improve compaction and reduce porosity, the tape laying head also includes a pre-heating module 70 for heating the laminate 100 before the tape 35 is laid onto the laminate. In particular, the pre-heating module is configured to be able to rapidly heat at least several layers of the laminate prior to the laminate being compacted by the compaction module 50. In the present instance, the pre-heating module 70 includes an induction heating head in the form of an induction coil 72. The coil 72 provides an electromagnetic field 75 and a flux concentrator 74 focus the electromagnetic field to provide inductive heating in the laminate. In particular, the inductive heater 70 heats the top layer 105 and one or more of the lower layers 106, 107 by electromagnetic induction, through heat generated by eddy currents. The pre-heater includes an electronic oscillator that passes a high-frequency alternating current through an electromagnet. The rapidly alternating magnetic field then penetrates the laminate to generate the eddy currents which in turn heat the top layer 105 and one or more layers below the top layer.

In this way, the pre-heating module 70 is configured to heat the laminate including at least one or more layers below the top layer and up to all of the layers in the laminate before the tape 35 is laid onto the laminate. By using an induction heating element, the pre-heater 70 directly heats one or more layers below the top layer 105 rather than applying heat to the top layer that then conducts through the layers.

An induction welding head 100 is then brought into operative engagement with the laminate to induce an electromagnetic field through the thickness of the laminate. In particular, the induction welding head 100 travels over the top surface of the laminate. The weld head need not contact the upper surface; however, the weld head is sufficiently close to the top surface of the laminate to induce an electromagnetic field through the thickness of the laminate having sufficient strength to weld the bottom layer 58a and the connecting element 39.

In the present instance, the weld head induces an electromagnetic field through the laminate and the connecting elements, so that the adjacent layers having transverse carbon fibers heat up in response to the electromagnetic field. In particular, in the present instance, the electromagnetic field produced by the preheater 70 is sufficient to heat the top layer 105 and one or more of the layers beneath the top layer. In the present instance, the coil 72 induces an electromagnetic field through the entire thickness of the laminate including layers 105, 106 and 107. However, it should be understood that the pre-heater may be configured and positioned to heat more than three layers. Similarly, the induction heater may be configured and positioned to heat only a few of the layers of the laminate rather than heating the entire laminate. In either instance, the layers are considered to be heated when the layer is heated to a temperature above the melting point of the resin that forms the matrix material for the layer. For instance, the matrix material may be PEEK material and the layer is considered to be heated if the pre-heater 70 heats the layer to a temperature above approximately 650° F. The pre-heater may be configured so that part of the electromagnetic field 75 extends into layers so that there is some heating effect on the layers but not sufficiently to heat the layer above the melting point of the matrix for the layer. Such a rise in temperature is not considered to be heated for purposes of this process.

A shown in FIGS. 1 & 2, the pre-heating module 70 is spaced apart from the weld zone 67 so that the pre-heater heats the laminate before the tape is applied to the top layer of the laminate. In particular, the pre-heating module is positioned upstream from the weld zone 67 so that the laminate is heated so that the top layer and one or more lower layers are heated to a melting stage.

### Method of Forming Laminate

The details of forming a laminate 100 will now be described. Referring to FIG. 2, the laminate is designated 100 and includes a top layer 105 and two lower layers 106 and 107. Tape 35 is laid onto the upper layer 105 to become the new layer 102.

A plurality of layers of carbon fiber reinforced thermoplastic tape are laid over top of one another to form a plurality of plies that are structural layers. The fiber orientation in the plies may be varied and insulating plies may be positioned in the interface of plies having transverse fiber orientations. For example, the layers may be formed of five structural plies oriented at 90°, 0°, 45°, 0°, 90°. In this exemplary laminate, the carbon fiber layers of the structural layers are formed of PEEK/AS4 carbon fiber reinforced unidirectional tape.

The structural are consolidated to form a laminate by heating the assembled plies under pressure. For instance, the assembly may be heated up to a temperature above the melting temperature. In the present instance, the assembled layers are heated to approximately 725° under a pressure of approximately 100 psi. The consolidated laminate is then cooled to ambient temperature.

The laminate is formed by an additive process of laying down carbon fiber tape piece by piece to build up a plurality of layers. In FIG. 2 each layer is illustrated as a single strip of carbon fiber tape, but it should be understood that each layer will typically comprise a plurality of strips of tape to form a layer having a length and width to conform to the shape of the form 5. The first layer is formed by controlling the control arm 20 to displace the tape laying head along a path over the form 5. As the control arm 20 displaces the head 30, the head advances the tape 35 to lay down the tape as the head moves along the form. The tape heating module 60 heats the tape in the weld zone as the tape is being laid onto the form. The compaction module 50 applies pressure to the heated tape to urge the tape into the shape of the form 5. After the head lays down a pre-determined length of tape onto the form the cutting element severs the tape. The control arm adjusts the position of the head to lay another length of tape onto the form adjacent previously laid layer of tape. This process continues until the tape laying head has laid a sufficient number of pieces to form the first layer of the laminate. The control arm then moves control head to follow a different path for laying down the tape for the second layer of the laminate. In particular, the control arm follows a path so that the pieces laid down for the second layer have a fiber orientation that is transverse the fiber orientation of the first layer. While laying the first and second layers, the pre-heating module 70 may not be activated. However, when laying the third and subsequent layers, preferably the pre-heating module 70 is activated.

Referring to FIG. 2, the process for laying the fourth layer onto three previously laid layers will be described. The newly laid layer is designated 102, which is laid on the top layer designated 105 (after the new layer is laid, it becomes the new top lay for laying the subsequent layer). The layer below the top layer is designated 106 and the bottom layer is designated 107. It should be understood that the bottom layer 107 is in contact with the form 5 and was the first layer laid by the head 30.

While laying the fourth layer 102, the control arm 20 displaces the tape laying head along a path to lay one or more lengths of tape 35 onto the top layer 105 so that the fiber orientation of the fourth layer is transverse the fiber orientation of the top layer 105. The pre-heating module is actuated as the tape laying head 30 is moved over the top layer 105. The pre-heating module 70 induces an electromagnetic field through the laminate, so that the adjacent layers having transverse carbon fibers heat up in response to the electromagnetic field. In particular, in the present instance, the electromagnetic field produced by the heating head is sufficient to heat the top layer 105 and lower layers 106, 107 above the melting temperature of the thermoplastic matrix material in the layers. Further, the pre-heating module extends across the entire width of the tape so that the pre-heating module heats the portion of layers 105, 106 and 107 corresponding to the width of the tape being laid. The head lays the tape 35 onto the heated laminate and the tape heating module 60 heats the tape and the top layer 105 in the weld zone 67. The tape heating module may heat the tape and the upper layer 105 to a temperature higher than the temperature that the pre-heating module heats the laminate.

From the weld zone, the tape and the laminate pass under the compaction roller 52. The roller applies pressure against the newly laid tape to press the new tape against the top layer 105 to fuse the tape onto the top layer so that the tape become the new top layer 102. The pressure applied by the compaction roller compacts the layers in the laminate that were heated above the melting point. In particular, the pressure of the compaction module is applied across the width of the tape and the force is applied to all of the layers below the tape. The pressure squeezes the layers together and the layers that were heated to a temperature above the melting point of their matrix material are free to flow under the pressure. Additionally, the pressure operates on the melted layers to squeeze gas pockets that may remain within the melted layers to transport the gas pockets out of the laminate to reduce voids in the matrix material.

In accordance with the following process, the control arm moves in a direction, such as direction “A” indicated in FIG. 1. As the control arm moves, the pre-heating module 70 heats the laminate upstream from the tape being laid. The tape is advanced into the weld zone 67 at an intersection with the laminate downstream from the pre-heating module. The compaction module 50 positioned downstream from the weld zone 67 rolls over the heated tape and the heated laminate to fuse the tape to the laminate and to compact the tape and the laminate.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. An apparatus for forming a multi-layer carbon fiber reinforced thermoplastic laminate on a form, comprising:
a holder configured to hold a length of carbon fiber reinforced thermoplastic tape, wherein the tape has a width and the thermoplastic of the tape has a melting point;
a feeder for advancing the tape from the holder toward an intersection, wherein the intersection comprises the location where the tape intersects with the form or the laminate;
a tape heating device configured to heat the tape and a top layer of the laminate to a first temperature, wherein the tape heating element directs the heat at the intersection across substantially the entire width of tape, wherein the first temperature is above the melting point of the tape thermoplastic;
a compaction device configured to apply pressure against the tape adjacent the intersection to fuse the tape with the laminate after the tape heating element heats the tape and the top layer of the laminate to the first temperature;
a laminate heating device comprising an induction heating device, wherein the laminate heating device is spaced apart from the compaction device so that the laminate heating device is positioned so that the laminate heating device heats the laminate without heating the tape being applied to the laminate; and
a drive assembly connected with the tape heating device, compaction device and laminate heating device, wherein the drive assembly is operable to control the position of the tape heating device, compaction device and laminate heating device, wherein the drive assembly is configured to displace the tape heating device, compaction device and laminate heating device along X,Y and Z axes.

2. The apparatus of claim 1 wherein the compaction device comprises a roller configured to form a nip with the laminate, wherein the nip forms the intersection and the feeder feeds the tape into the nip.

3. The apparatus of claim 2 wherein the roller comprises an elastically deformable flexible surface configured to deform to generally correlate with a surface of the form or laminate.

4. The apparatus of claims 1 wherein the induction heating device comprises an induction coil for producing an electromagnetic field and a flux concentrator for concentrating the electromagnetic field toward the laminate.

5. The apparatus of claim 4 wherein the induction heating device is positioned to induce the electromagnetic field into several layers of the laminate to directly heat one or more layers of the laminate.

6. The apparatus of claim 5 wherein directly heating means that the one or more layers of the laminate are heated by a mechanism other than conductive heating through the top layer of the laminate.

7. The apparatus of claim 1 wherein the laminate heating device is configured to heat a portion of the laminate before tape is laid over the portion.

8. The apparatus of claim 7 wherein the laminate heating device heats the laminate across substantially the entire width of the laminate corresponding to the width of the tape.

9. The apparatus of claim 8 wherein the laminate heating device is configured to heat the tape and the top layer of the laminate at the intersection to over 500° F. within one second.

10. The apparatus of claim 1 wherein the holder comprises a reel or a spool.

11. The apparatus of claim 10 wherein the tape is pre-impregnated tape or fibers and the reel or spool is configured to receive a length of pre-impregnated tape or fibers wound about a hub of the reel or spool.

12. The apparatus of claim 11 comprising an electronic controller for controlling the position of the drive assembly to follow a predetermined path.

13. The apparatus of claim 12 wherein the electronic controller is operable to vary the direction of travel of the drive assembly to that the orientation of the reinforcing fibers in the tape is transverse the orientation of reinforcing fibers in the top layer of the laminate.

14. The apparatus of claim 1 wherein the intersection forms a line across the width of the tape and the tape heating device comprises a laser heater configured to heat the tape to the first temperature along the line.

15. The apparatus of claim 1 wherein the compaction device is configured to apply pressure to the top layer while the tape is moving relative to the compaction device.

16. An apparatus for forming a multi-layer carbon fiber reinforced thermoplastic laminate on a form, comprising:
a drive assembly; and
a tape laying assembly connected with the drive assembly, wherein the drive assembly is configured to displace the tape laying assembly along at least two axes, wherein the tape laying assembly comprises:
a feed module operable to feed carbon fiber reinforced tape toward the form or onto a top surface of one or more layers of carbon fiber reinforced thermoplastic laid on the form;
a tape heating module configured to heat the tape and the top surface at a point where the tape is laid on the top surface;
a compaction module positioned downstream from the point where the tape heating module heats the tape and the top surface; wherein the compaction module is configured to apply pressure to the tape to fuse the tape with the top layer;
a pre-heating module positioned upstream from the point where the tape heating module heats the tape and the top surface; wherein the pre-heating module is configured to heat a plurality of the layers on the form prior to the tape being laid onto the plurality of layers.

17. The apparatus of claim 16 wherein the pre-heating module is configured to heat the plurality of layers to an elevated temperature above the melting point of the thermoplastic in the layers so that the compaction module compacts the plurality of layers when the compaction module applies pressure to the tape.

18. The apparatus of claim 17 wherein the compaction module applies pressure to the tape while the tape is displaced relative to the compaction module.

19. The apparatus of claim 16 wherein the compaction module comprises a roller wherein the roller forms a nip with the form or the top surface of the one or more layers, wherein the feeder module feeds the tape into the nip.

20. The apparatus of claim 16 wherein the pre-heating module comprises an induction coil for producing an electromagnetic field and a flux concentrator for concentrating the electromagnetic field toward the plurality of layers.

21. The apparatus of claim 20 wherein the induction heating device is positioned to induce the electromagnetic field into several layers of the plurality of layers to directly heat the several layers.

22. The apparatus of claim 21 wherein directly heating means that the several layers are heated by a mechanism other than conductive heating through the top surface.

23. The apparatus of claim 16 wherein the pre-heating module is configured to heat a portion of the carbon fiber reinforced thermoplastic layers on the form before tape is laid over the portion.

24. The apparatus of claim 16 wherein the pre-heating module is configured to heat the layers on the form without heating the tape.

25. The apparatus of claim 24 wherein the tape travels along a path through the tape laying assembly and wherein the pre-heating module is spaced apart from the path so that the pre-heating module heats the layers on the form without heating the tape travelling along the path.

26. The apparatus of claim 16 comprising an electronic controller for controlling the position of the drive assembly to follow a predetermined path wherein the electronic controller is operable to vary the direction of travel of the drive assembly so that the orientation of the reinforcing fibers in the tape is transverse the orientation of reinforcing fibers in the top layer of plurality of layers on the form.

27. The apparatus of claim 26 wherein the tape heating device comprises a laser heater configured to heat the tape to the first temperature along a line that extends substantially the entire width of the tape at the point where the tape is laid on the top surface.
